(19) United States
(12) Patent Application Publication
(10) Pub. No.: US 2013/0016394 A1
(43) Pub. Date: Jan. 17, 2013

(54) IMAGE PROCESSING APPARATUS, DATA PROCESSING METHOD IN IMAGE PROCESSING APPARATUS, AND STORAGE MEDIUM STORING PROGRAM THEREOF

(71) Applicant: Takashi Isoda, Kawasaki-shi (JP)

(72) Inventor: Takashi Isoda, Kawasaki-shi (JP)

(73) Assignee: CANON KABUSHIKI KAISHA, Tokyo (JP)

(21) Appl. No.: 13/536,312

(22) Filed: Jun. 28, 2012

(30) Foreign Application Priority Data
Jul. 15, 2011 (JP) 2011-157122

(51) Int. Cl. H04N 1/04

(52) U.S. Cl. 358/1.15; 358/474

(57) ABSTRACT

A first electronic file generated by reading an image is attached to a second electronic file having a security function. By executing the security function of the second electronic file to which the first electronic file has been attached, the security function is executed with respect to the first electronic file.

### BACKGROUND OF THE INVENTION

1. Field of the Invention

The present invention relates to an image processing apparatus for reading images, a method of data processing in the image processing apparatus, and a storage medium storing a program for implementing the method.

2. Description of the Related Art

As in the manner of a file-attaching function used in a PDF, for example, a function known in the art is capable of attaching to an electronic file another file having a different format, and of extracting the attached file from the electronic file. The attaching operation is executed within the application corresponding to the electronic file and, as a result, it is possible to work with multiple files together as a single file. In addition, such a function allows a function that is effective only in an electronic file to be executed with respect also to an attached file having a different format. For example, a PDF file allows execution of an encryption function in an attached file [see PDF (Portable Document Format) Ver. 1.7 (Adobe Systems Incorporated)].

On the other hand, the optical reading of documents and generation of electronic files in an image processing apparatus is well known. Such an image processing apparatus is capable of reading documents and generating files in various formats.

However, a value-added function such as encryption cannot be applied to a file other than a file in a specific format, such as PDF. In order to apply such a function to a file other than one having a specific format, therefore, it is required that the file be converted, as by a personal computer, to one having the specific format. The need to convert the file results in increased labor as far as the user is concerned.

### SUMMARY OF THE INVENTION

An aspect of the present invention is to eliminate the above-mentioned problems with the conventional technology.

The present invention provides an image processing apparatus in which user labor is reduced by executing a security function with regard to a file read in the image processing apparatus, a method of data processing in the image processing apparatus, and a storage medium storing a program for implementing the method.

The present invention in its first aspect provides an image processing apparatus having a reading unit for reading an image, comprising: a generation unit configured to generate a first electronic file by reading the image using the reading unit; an attachment unit configured to attach the first electronic file, which has been generated by the generation unit, to a second electronic file having a security function; and an execution unit configured to execute the security function with respect to the first electronic file by executing the security function of the second electronic file to which the first electronic file has been attached by the attachment unit.

The present invention in its second aspect provides a data processing method executed by an image processing apparatus having a reading unit for reading an image, comprising: a generation step of generating a first electronic file by reading the image using the reading unit; an attachment step of attaching the first electronic file, which has been generated at the generation step, to a second electronic file having a security function; and an execution step of executing the security function with respect to the first electronic file by executing the security function of the second electronic file to which the first electronic file has been attached at the attachment step.

The present invention in its third aspect provides a computer-readable storage medium storing a program for causing a computer to execute: a generation step of generating a first electronic file by reading the image using the reading unit; an attachment step of attaching the first electronic file, which has been generated at the generation step, to a second electronic file having a security function; and an execution step of executing the security function with respect to the first electronic file by executing the security function of the second electronic file to which the first electronic file has been attached at the attachment step.

In accordance with the present invention, user labor can be reduced by having an image processing apparatus execute a security function with regard to a file read in the apparatus.

Further features of the present invention will become apparent from the following description of exemplary embodiments with reference to the attached drawings.

### BRIEF DESCRIPTION OF THE DRAWINGS

FIG. 1 is a diagram illustrating the hardware configuration of an image processing apparatus;

FIG. 2 is a flowchart illustrating data processing according to a first embodiment of the present invention;

FIG. 3 is a diagram illustrating an example of file format selection screen;

FIG. 4 is a diagram illustrating an example of a value-added-function selection screen regarding the PDF format;

FIG. 5 is a diagram illustrating an example of a value-added-function selection screen regarding the ZIP format;

FIG. 6 is a table illustrating correspondence between file formats and implementable value-added functions;

FIG. 7 is a diagram illustrating an example of a screen for setting file name after attachment processing;

FIG. 8 is a flowchart illustrating data processing according to a second embodiment of the present invention;

FIG. 9 is a diagram illustrating an example of a value-added-function selection screen in this embodiment; and

FIG. 10 is a diagram illustrating an example of a file format selection screen in this embodiment.

### DESCRIPTION OF THE EMBODIMENTS

Preferred embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention. It should be noted that identical structural elements are designated by like reference characters and are not described redundantly.

### First Embodiment

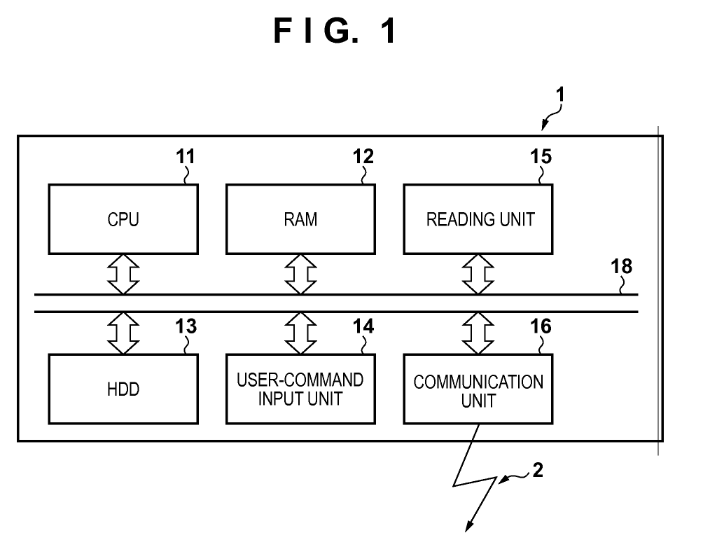

FIG. 1 is a block diagram illustrating the hardware configuration of an image processing apparatus 1 according to an embodiment of the present invention. The image processing apparatus 1 is, for example, an MFP (Multi-Function Peripheral) and is capable of communicating with other devices connected to a network via a communication unit 16 and communication line 2. A CPU 11 controls the blocks within the image processing apparatus 1. A RAM 12 is used as the work area of the CPU 11. A hard-disk drive (HDD) 13 provides a program for practicing this embodiment and stores various settings and files. An NVRAM may be used instead of the hard-disk drive 13. A user-command input unit 14 accepts settings entered by the user via a GUI (Graphical User Interface). A reading unit 15 reads a document optically and generates electronic data. The blocks shown in FIG. 1 are interconnected via a main bus 18. Unless specifically stated otherwise in this embodiment, the CPU 11 executes the processing shown in the flowcharts below by controlling the RAM 12, hard-disk drive 13, user-command input unit 14, reading unit 15 and communication unit 16. The image processing apparatus 1 may be connected to an apparatus such as a server via the network.

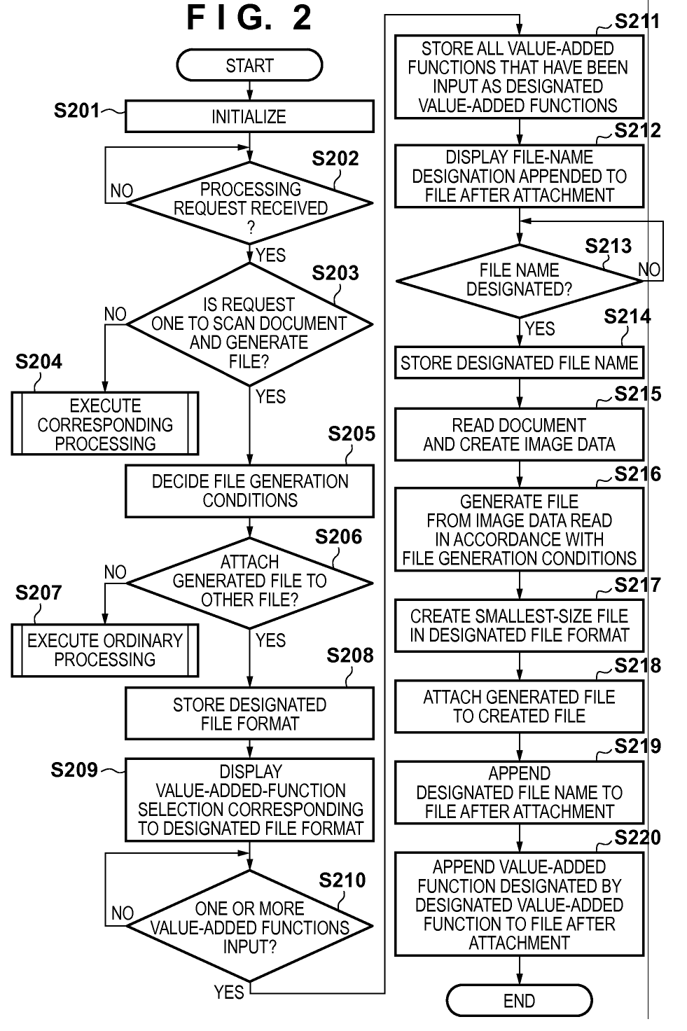

FIG. 2 is a flowchart illustrating data processing executed by the image processing apparatus 1 according to this first embodiment. Each of the processing steps shown in FIG. 2 is executed, for example, by the CPU 11 of image processing apparatus 1. When power is introduced to the image processing apparatus 1, each unit in the image processing apparatus 1 starts up and the CPU 11 initializes each of these units (step S201). The CPU 11 waits for input of a processing request from the user (step S202). When the processing request is input, the CPU 11 determines whether the processing request is a request for having the reading unit 15 optically read a document and generate an electronic file (step S203). If it is determined that the request is not a request for optically reading a document and generating an electronic file, then the processing conforming to this request is executed and the processing of this flowchart is exited (step S204). On the other hand, if it is determined that the request is a request for optically reading a document and generating an electronic file, then the CPU 11 acquires the generation conditions (such as the file name, file format and resolution) of the electronic file to be generated by reading the document (step S205). It may be arranged so that the generation conditions are acquired from reading settings designated by the user.

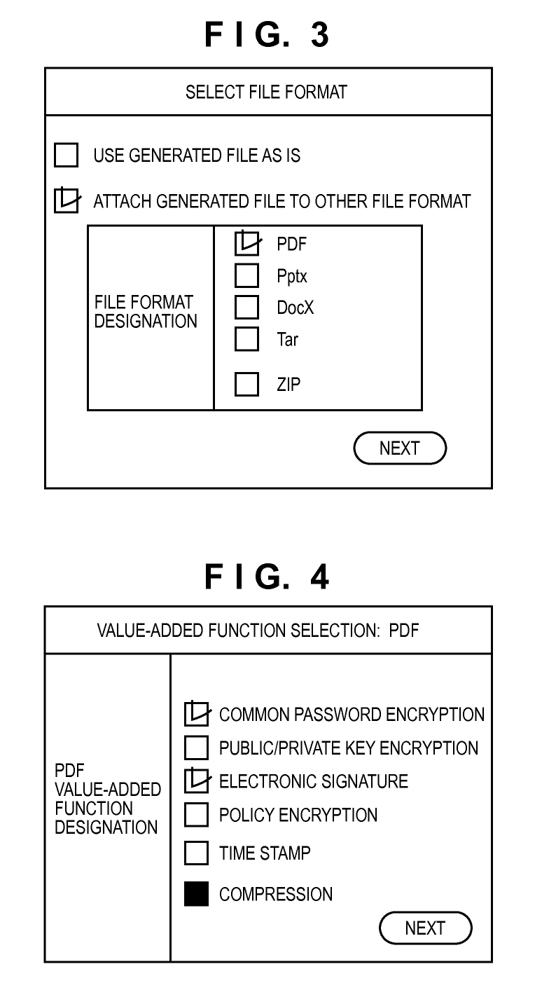

Next, in order to allow the user to select whether the electronic file generated by reading the document is to be attached to another electronic file, the CPU 11 displays a selection screen for this purpose on the user-command input unit 14. FIG. 3 is a diagram illustrating this selection screen. As shown in FIG. 3, the CPU 11 uses the selection screen to allow the user to select the format of the electronic file to which the electronic file generated by reading the document is to be attached. Here the user can select only one format as the format of the electronic file that is the destination of the attachment. At step S206, the CPU 11 determines whether it has received a choice to attach the electronic file generated by reading the document to another electronic file. If the CPU 11 has not received a choice to attach the electronic file generated by reading the document to another electronic file, then the CPU 11 executes ordinary read processing and exits the processing of this flowchart (step S207).

If it is determined at step S206 that a choice to attach the electronic file generated by reading the document to another electronic file has been received, the CPU 11 temporarily stores the selected format of the electronic file that is the destination of the attachment in a memory such as the RAM 12 (step S208). Next, the CPU 11 displays a value-added-function selection screen, which corresponds to the selected format of the electronic file that is the destination of the attachment, on the user-command input unit 14 (step S209). Here the value-added function refers to a security function such as setting of a password or encryption regarding an electronic file. FIG. 4 is a diagram illustrating an example of this value-added-function selection screen. As shown in FIG. 4, the user is capable of selecting a plurality of functions.

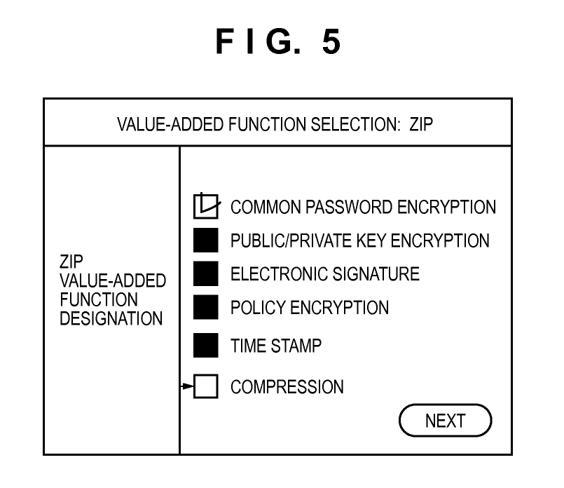

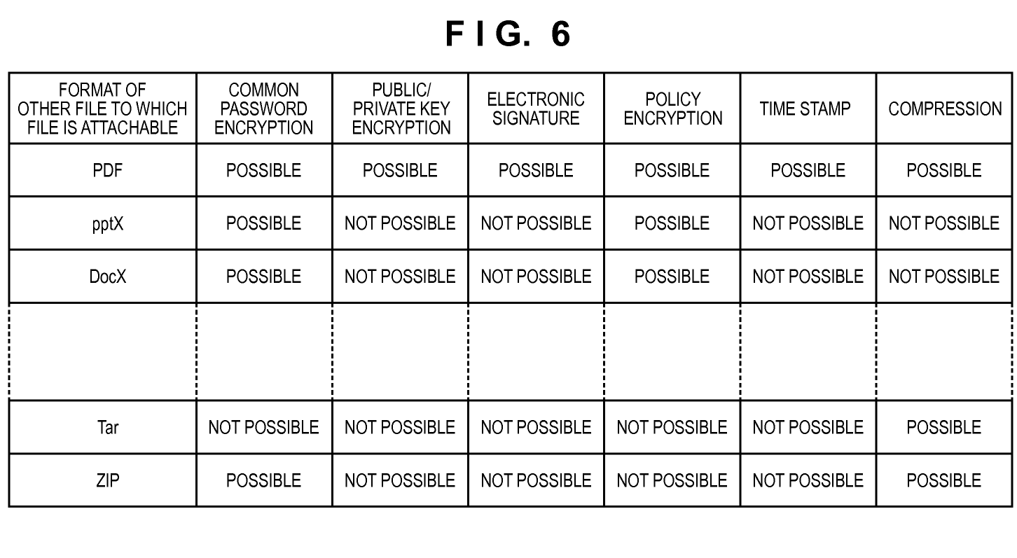

The items capable of being selected by the user on this value-added-function selection screen differ depending upon the format received by selection using the selection screen shown in FIG. 3. For example, FIG. 4 is a selection screen displayed in a case where PDF has been selected on the screen shown in FIG. 3. FIG. 5 is a selection screen displayed in a case where ZIP has been selected on the screen shown in FIG. 3. FIGS. 4 and 5 are examples of a third display. In this embodiment, various formats of electronic files that are the destination of an attachment and value-added functions executable with regard to each format have been correlated and stored beforehand on the hard-disk drive 13 or the like in the form of the table shown in FIG. 6. By referring to the table shown in FIG. 6, the CPU 11 designates the executable functions corresponding to the format selected by the user in FIG. 3 and displays these designated functions so that a selection can be made by the user.

The CPU 11 waits until it has accepted selection of at least one value-added function (step S210) and temporarily stores all accepted value-added functions in a memory such as the RAM 12 (step S211). The CPU 11 displays a screen, which is for designating a file name to be appended to an electronic file following the attachment processing of this flowchart, on the user-command input unit 14 (step S212) and waits for input of the file name (step S213).

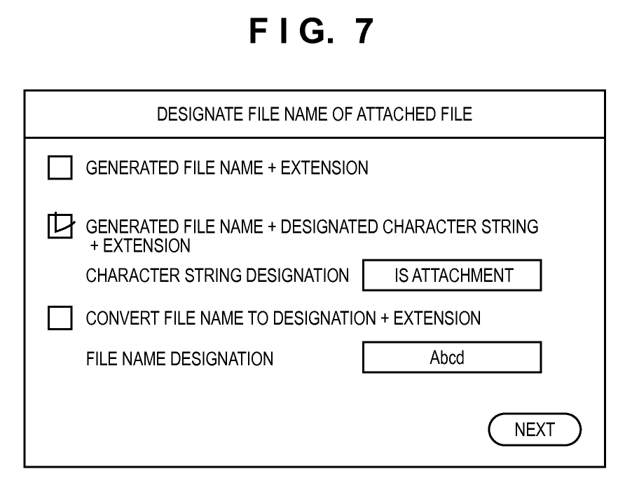

FIG. 7 is a diagram illustrating an example of a screen for appending a file name. In this embodiment, the user is capable of selecting from among a plurality of methods of appending the file name. One selectable method is a method of combining and appending the file name of an electronic file generated by optically reading a document and an extension corresponding to the format selected in FIG. 3. For example, if the file name of the generated electronic file is “1234.jpg” and the PDF format has been selected in FIG. 3, then “1234.jpg.pdf” is appended as the file name. Another selectable method is a method of combining and appending the entirety or part of the file name (inclusive of an extension) of an electronic file generated by reading the document and an extension corresponding to the format selected in FIG. 3, and yet another selectable method is a method of further combining a designated character string with the above and appending the result. For example, if the file name of the generated electronic file is “1234.jpg” and the PDF format has been selected in FIG. 3, then “1234.jpg is attachment.pdf” is appended as the file name. A further selectable method is a method of converting the entirety of the file name of the electronic file generated by reading the document to a designated character string. For example, if the file name of the generated electronic file is “1234.jpg” and the PDF format has been selected in FIG. 3, then “Abcd.pdf” is appended as the file name. The CPU 11 temporarily stores the electronic file name, appended in the manner described above, in a memory such as the RAM 12 (step S214).

Next, the CPU 11 reads the document and generates image data using the reading unit 15 (step S215) and, in accordance with the generation conditions designated at step S205, generates an electronic file (let this be a “first electronic file”) from the image data (step S216). Next, the CPU 11 generates an electronic file (let this be a “second electronic file”) which has the format stored at step S208 and, moreover, a file size that is the minimum size (step S217). In this embodiment, the electronic file is a PDF-format electronic file that does not include any image data to be printed. In this embodiment, the electronic file generated at step S217 plays the roll of a mount for attaching the electronic file read and generated at steps S215 and S216.

The CPU 11 attaches the electronic file generated by reading the document at steps S215 and S216 to the electronic file generated at step S217 (step S218). The CPU 11 then appends the file name stored at step S214 to the electronic file generated at step S218 (step S219). Next, the CPU 11 appends the value-added function stored at step S211 to the electronic file to which the file name has been appended (step S220). The value-added function is appended by a method that is in accordance with each format such as PDF or ZIP and each value-added function.

### Second Embodiment

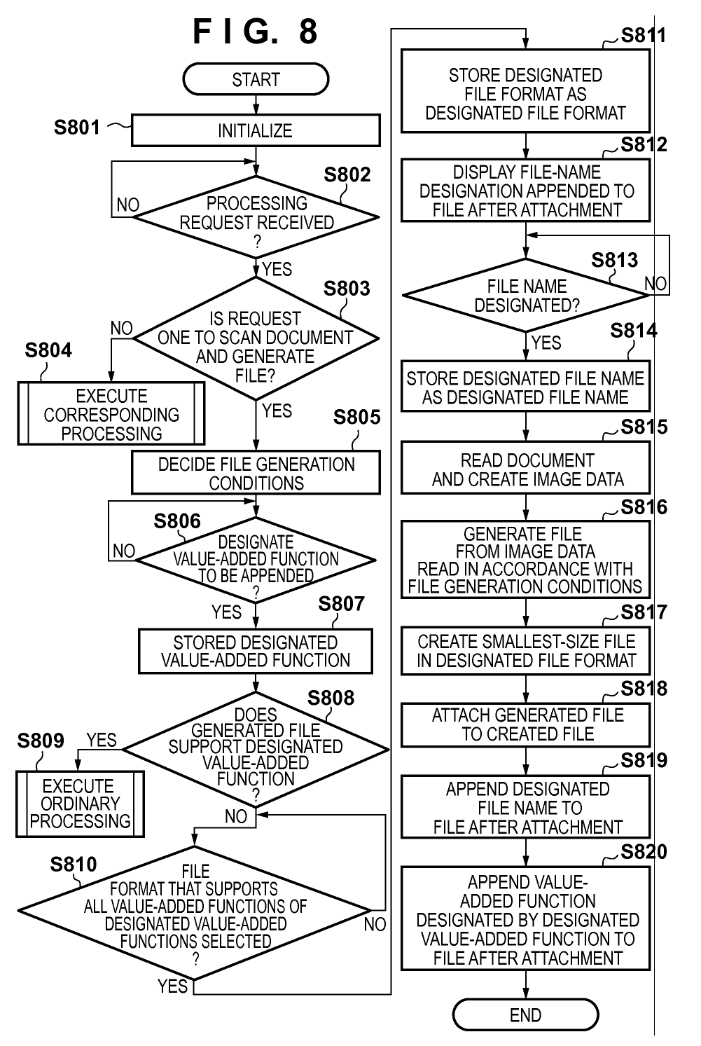

FIG. 8 is a flowchart illustrating data processing in the image processing apparatus 1 according to this embodiment. Each processing step shown in FIG. 8 is executed by the CPU 11 of the image processing apparatus 1. The flowchart shown in FIG. 8 differs from that shown in FIG. 2 in steps S801 to S811. Steps S812 to S820 are identical with the processing steps S212 to S220 shown in FIG. 2.

When power is introduced to the image processing apparatus 1, each unit in the image processing apparatus 1 starts up and the CPU 11 initializes each of these units (step S801). The CPU 11 waits for input of a processing request from the user (step S802). When the processing request is input, the CPU 11 determines whether the processing request is a request for having the reading unit 15 optically read a document and generate an electronic file (step S803). If it is determined that the request is not a request for optically reading a document and generating an electronic file, then the processing conforming to this request is executed and the processing of this flowchart is exited (step S804). On the other hand, if it is determined that the request is a request for optically reading a document and generating an electronic file, then the CPU 11 acquires the generation conditions (such as the file name, file format and resolution) of the electronic file to be generated the reading the document (step S805). It may be arranged so that the generation conditions are acquired from reading settings designated by the user.

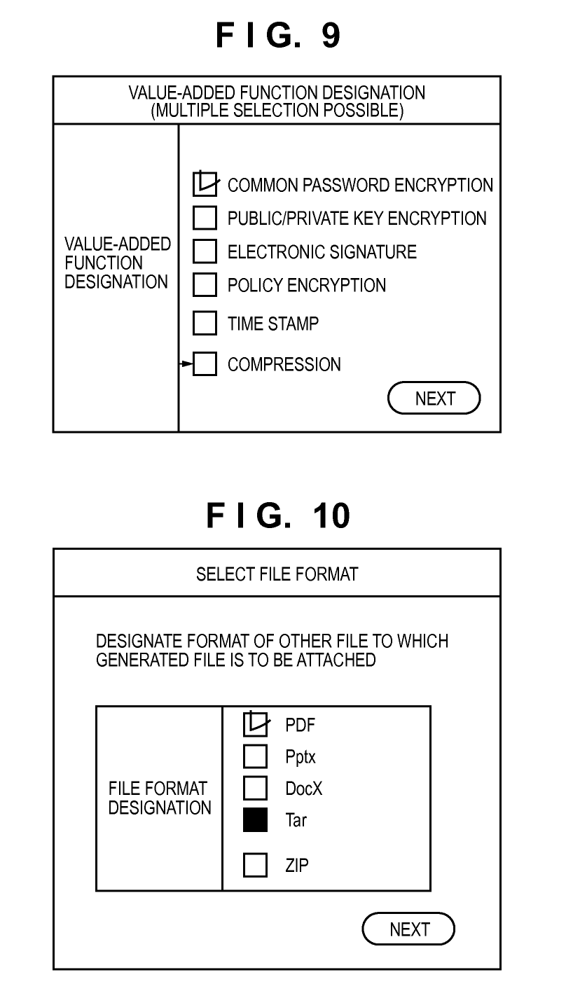

Next, the CPU 11 displays a screen on the user-command input unit 14 that makes it possible to select whether a value-added function will be appended to the electronic file generated by reading the document or to select what value-added function will be appended. FIG. 9 is a diagram illustrating a value-added-function selection screen in this embodiment. As shown in FIG. 9, it is possible for the user to select at least one value-added function. The CPU 11 waits until it has accepted selection of at least one value-added function (step S806) and, upon accepting the user's choice, temporarily stores all selected value-added functions in a memory such as the RAM 12 (step S807).

The CPU 11 determines whether the format of the file generated (generated by reading the document) based upon the generation conditions designated at step S805 supports the value-added function stored at step S807 (step S808). The CPU 11 makes the determination at step S808 by referring to the table shown in FIG. 6. If it is determined that the format of the file generated by reading the document supports the value-added function stored at step S807, then the CPU 11 executes the usual processing for implementing this value-added function with respect to the file generated by reading the document (step S809).

If it is determined that the format of the file generated by reading the document does not support the value-added function stored at step S807, then the CPU 11 displays formats capable of supporting the value-added function stored at step S807 on the user-command input unit 14 in a selectable manner. FIG. 10 is a diagram illustrating a format selection screen according to this embodiment. By referring to the table shown in FIG. 6, the CPU 11 presents a display which specifies formats capable of supporting the value-added function stored at step S807 and which makes unsupportable formats unselectable as by dimming the indication of such formats. Further, the user can select only one format in FIG. 10. The CPU 11 waits for the user to make the selection on the screen of FIG. (step S810). The CPU 11 temporarily stores the format selected in FIG. 10 in the RAM 12.

By virtue of this embodiment, a file format corresponding to a value-added function desired by a user can be selected for an electronic file generated by reading a document.

In the first and second embodiments, an electronic file generated by having a reading unit 15 read a document has been described. However, the present invention may be applied to an electronic file generated by some other method. For example, the present invention may be applied to files such as a settings file in which various settings of an image processing apparatus have been written or a destination file such as a list of transmission destinations. Further, in a case where an image processing apparatus is equipped with a file server function, the invention may be applied to a file that has been stored by the file server function. By virtue of this embodiment, various electronic files can be furnished with various value-added functions that originally could not added on to the formats of these electronic files.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-157122, filed Jul. 15, 2011, which is hereby incorporated by reference herein in its entirety.

What is claimed is:

1. An image processing apparatus having a reading unit for reading an image, comprising:
a generation unit configured to generate a first electronic file by reading the image using the reading unit;
an attachment unit configured to attach the first electronic file, which has been generated by said generation unit, to a second electronic file having a security function; and
an execution unit configured to execute the security function with respect to the first electronic file by executing the security function of the second electronic file to which the first electronic file has been attached by said attachment unit.

2. The apparatus according to claim 1, further comprising a first display unit configured to selectably display whether or not the first electronic file is to be attached to the second electronic file;
wherein said attachment unit attaches the first electronic file to the second electronic file if said attachment unit has accepted a selection indicating that the first electronic file is to be attached.

3. The apparatus according to claim 1, further comprising a table in which a format of the second electronic file is associated with security functions supportable by this format.

4. The apparatus according to claim 3, further comprising:
a second display unit configured to selectably display a plurality of formats of the second electronic file; and
a third display unit configured to selectably display a plurality of security functions supportable by a format selected from the plurality of formats, which are displayed by said second display unit, by referring to said table.

5. The apparatus according to claim 3, further comprising:
a fourth display unit configured to selectably display a plurality of security functions; and
a fifth display unit configured to selectably display a plurality of formats of the second electronic file capable of supporting a security function selected from the plurality of security functions, which are displayed by said fourth display unit, by referring to said table.

6. A data processing method executed by an image processing apparatus having a reading unit for reading an image, comprising:
a generation step of generating a first electronic file by reading the image using the reading unit;
an attachment step of attaching the first electronic file, which has been generated at said generation step, to a second electronic file having a security function; and
an execution step of executing the security function with respect to the first electronic file by executing the security function of the second electronic file to which the first electronic file has been attached at said attachment step.

7. A computer-readable storage medium storing a program for causing a computer to execute:
a generation step of generating a first electronic file by reading the image using the reading unit;
an attachment step of attaching the first electronic file, which has been generated at said generation step, to a second electronic file having a security function; and
an execution step of executing the security function with respect to the first electronic file by executing the security function of the second electronic file to which the first electronic file has been attached at said attachment step.
